(19) United States
(12) Patent Application Publication
(10) Pub. No.: US 2007/0003796 A1
(43) Pub. Date: Jan. 4, 2007

(54) Method for manufacturing magnetic disk glass substrate and method for manufacturing magnetic disk

(75) Inventors: Hideki Isono, Tokyo (JP); Katsuyuki Iwata, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 11/445,270

(22) Filed: Jun. 2, 2006

(30) Foreign Application Priority Data
Jun. 3, 2005 (JP) 2005-164167

(51) Int. Cl. C03C 15/00; B05D 5/12; G11B 5/66

(52) U.S. Cl. 428/832; 65/30.14; 427/128

(57) ABSTRACT

A method for manufacturing a magnetic disk glass substrate including a chemical strengthening step is provided. In the method, chemical strengthening treatment is sufficiently performed over the entire main surfaces of a glass substrate. Consequently, the resulting magnetic disk glass substrate can provide a magnetic disk allowing the magnetic head to have a low flying height and achieving high-density information recording, and particularly a magnetic desk suitably used in small hard disk drives for portable information apparatuses. In the chemical strengthening step, a chemical strengthening agent is brought into contact with a glass substrate to perform ion exchange by allowing the chemical strengthening agent to flow with respect to the glass substrate, or by moving the glass substrate with respect to the chemical strengthening agent.

This application claims priority to prior Japanese patent application JP2005-164167, the disclosure of which is incorporated herein by reference.

### BACKGROUND OF THE INVENTION

The present invention relates to a method for manufacturing a magnetic disk glass substrate of a magnetic desk used in magnetic disk devices, such as hard disk drives (HDD's), and to a method for manufacturing a magnetic disk including the magnetic disk glass substrate.

As the information technology is developing, dramatic innovation on information technology, particularly on magnetic recording technology, is desired more and more. In a magnetic disk used in a hard disk drive (HDD) being a magnetic disk device as a computer storage, the information recording density is being increased rapidly, unlike in other types of magnetic recording media, such as magnetic tapes and flexible disks. Accordingly, the information recording capacity of a hard disk drive contained in a personal computer is dramatically increasing on the strength of the increase in information recording density of the magnetic disk.

The magnetic disk includes a magnetic recording layer and other layers that are formed on a substrate made of, for example, glass or an aluminum-based alloy. In a hard disk drive, the magnetic disk is rapidly spun under a flying magnetic head, and the magnetic head records information signals as magnetized patterns on the magnetic recording layer, or reproduces the recorded information signals.

The information recording density of the magnetic disk has been increased to as high as more than 40 gigabits per square inch, and further an ultra-high recording density of more than 100 gigabits per square inch is being realized. Such a recent magnetic disk with a high information recording density can store a sufficient amount of information in a much smaller area than known magnetic disks, such as flexible disks.

The magnetic disk has an extremely high information recording speed or reproduction speed (response speed), in comparison with other information recording media, and allows information writing or reading anytime.

These features of the magnetic disk arouse a demand for such a small hard disk drive as can be installed in portable apparatuses much smaller than personal computers, requiring high response speed, such as cellular phones, digital cameras, portable information apparatuses (for example, PDA's (personal digital assistants)), and car navigation systems.

Accompanying the demand (for mobile use) that the small hard disk drive be used in portable apparatuses, hard substrates made of glass are being mainly used as the substrate of the magnetic disk. This is because the glass substrate has higher strength and stiffness than metal substrates. In addition, the glass substrate can have a smooth surface. Accordingly the glass substrate facilitates narrowing of the flying height (reducing of the flying height) of the magnetic head that records and reproduces information while being floating over the magnetic disk. Thus, a magnetic disk having a high information recording density can be achieved.

On the other hand, the glass substrate has a brittle nature, and a variety of approaches have been proposed to strengthen the glass substrate. Among these approaches is chemical strengthening treatment. In the chemical strengthening treatment, the glass substrate is immersed in a chemical strengthening bath heated to about 300° C. and containing a chemical strengthening agent (a nitrate solution), such as sodium nitrate (NaNO₃) or potassium nitrate (KNO₃), for a predetermined time so that the lithium ions (Li⁺) at the surfaces of the glass substrate are replaced with sodium ions (Na⁺) or potassium ions (K⁺), or the sodium ions (Na⁺) at the surfaces of the glass substrate are replaced with potassium ions (K⁺). Thus, compressive stress layers are formed over both surfaces of the glass substrate and the layer between the compressive stress layers acts as a tensile stress.

Japanese Unexamined Patent Application Publications (JP-A) Nos. 2003-146703 and 2003-201148 have disclosed a holder to hold the glass substrate in the chemical strengthening bath for the chemical strengthening treatment. The holder includes a plurality of holding members to come into contact with the periphery (ends) of the glass substrate. The holding members catch a plurality of portions of the periphery (ends) of the glass substrate to hold the glass substrate in the chemical strengthening bath.

In addition, Japanese Patent (JP-B) No. 3172107 has disclosed a technique for preventing the generation of dust from the chemical strengthening bath or the holder by use of a stainless alloy bath and holder.

### SUMMARY OF THE INVENTION

In recent years, magnetic disks have been desired to be smaller and thinner, and the dimensions including the thickness of the glass substrate are being reduced. For example, the glass substrate of the magnetic disk used for “1 inch HDD” has a diameter of about 27.4 mm and a thickness of 0.381 mm; the glass substrate of the magnetic disk used for “0.85 inch HDD” has a diameter of about 21.6 mm.

Such a thin glass substrate is liable to warp, and accordingly the waviness (undulation) (Wa) may be disadvantageously increased before the chemical strengthening treatment. The waviness (Wa) can be represented by the average height Wa of waves with wavelengths of 300 μm to 5 mm in a region surrounded by two concentric circles defined by points predetermined distances away from the center on the surface of the glass substrate. The heights of the waves are measured by non-contact laser interferometry. The waviness, or average wave height, Wa is derived from the following equation:
Wa=(1/N)Σᵢ₌₁^{N}|Xi−Xa|

In the formula, Xi represents a measured value (height from a reference level to the curve of a wave) at a measuring point, Xa represents the average of measured values at measuring points, and N represents the number of measuring points.

In the chemical strengthening treatment, the glass substrate is immersed in a chemical strengthening agent for a predetermined time. Since the periphery (ends) of the glass substrate is in contact with the holder during the treatment, the regions held by the holder and their vicinities of the glass substrate may not be sufficiently treated. As the diameter of the glass substrate is reduced, the holder relatively increases in size. Downsizing the holder to be thinner and smaller has a limit from the viewpoint of maintaining the stiffness. The relatively increased size of the holder makes the above phenomenon significant.

If part of the glass substrate is not sufficiently treated by chemical strengthening, the compressive stress at the surface of the glass substrate becomes nonuniform. Consequently, the waviness (Wa) may further be increased disadvantageously.

If the waviness (Wa) of the surface of the glass substrate is increased to more than about 1 nm, the resulting magnetic disk using such a glass substrate negatively affects the flying height of the magnetic head. Although such a degree of waviness (Wa) did not cause problems formerly, it is now perceived as a problem because of the reduced flying height.

In order to solve the problem, the intervals between the glass substrates can be increased in the chemical strengthening bath. This solution however reduces the number of glass substrates that can be treated at one time and accordingly reduces the productivity. This is not suitable for the manufacture of small-diameter glass substrates requiring lower cost.

In view of the above-described circumstances, an object of the present invention is to provide a method for manufacturing a magnetic disk glass substrate used for magnetic disks that allow the magnetic head to have a lower flying height and achieve high density information recording. The method includes the chemical strengthening step of bringing a chemical strengthening agent into contact with the glass substrate to perform ion exchange, and thereby forming compressive stress layers over both main surfaces of the glass substrate and a tensile stress layer between the a compressive stress layers. The chemical strengthening agent contains ions with a larger radius than the ions in the glass substrate. The chemical strengthening step sufficiently performs chemical strengthening treatment over the entire main surfaces of the glass substrate so that the compressive stress at the surfaces of the glass substrate is uniform. Consequently, the waviness (Wa) can be kept a certain value or less, and a glide height can be reduced to a desired value or less. Accordingly, the method can be applied particularly to the manufacture of magnetic disk glass substrate used for magnetic disks suitably used in small hard disk drives for portable information apparatuses.

Another object of the invention is to provide a method for manufacturing a magnetic disk including the magnetic disk glass substrate. The magnetic disk allows the magnetic head to have a lower flying height and achieves high density information recording, and is suitably used in small hard disk drives for portable information apparatuses.

The inventors of the invention have found that the above-described problem in the chemical strengthening treatment can be overcome by appropriately moving the glass substrate and the chemical strengthening agent relatively with each other.

That is, this invention has any one of the following structures.

(Structure 1)

A method for manufacturing a magnetic disk glass substrate, comprising: the chemical strengthening step of bringing a chemical strengthening agent into contact with a glass substrate to perform ion-exchange, wherein the chemical strengthening agent is allowed to flow with respect to the glass substrate.

(Structure 2)

A method for manufacturing a magnetic disk glass substrate, comprising: the chemical strengthening step of bringing a chemical strengthening agent into contact with a glass substrate to perform ion exchange, wherein the glass substrate is moved with respect to the chemical strengthening agent.

(Structure 3)

The method according to Structure 2, wherein the glass substrate is held by a holder, and moved in the chemical strengthening agent with the holder swung at predetermined intervals.

(Structure 4)

A method for manufacturing a magnetic disk, comprising: the step of forming a magnetic recording layer on a magnetic disk glass substrate prepared by the method as set forth in any one of Structures 1 through 3.

(Structure 5)

A magnetic disk glass substrate manufactured by the method as set forth in any one of Structures 1 through 3, the magnetic disk glass substrate including a recording/reproducing region at the main surface thereof and being in a form of disk with a diameter of 1 inch or less, the recording/reproducing region having waves with wavelengths of 300 μm to 5 mm and an average height Wa of 1.0 nm or less, wherein the average height Wa is obtained by measuring the heights of the waves in a region surrounded by two concentric circles defined by points predetermined distances away from the center of the recording/reproducing region, by non-contact laser interferometry, and the average height Wa is derived from the equation:
Wa=(1/N)Σᵢ₌₁^{N}|Xi−Xa|

wherein Xi represents a measured value that is a height from a reference level to the curve of a wave; Xa represents the average of measured values at measuring points; and N represents the number of measuring points.

In the chemical strengthening step in the method for manufacturing a magnetic disk according to this invention, the chemical strengthening agent is allowed to flow with respect to the glass substrate. Therefore, a fresh flow of the chemical strengthening agent always comes in contact with the main surfaces of the glass substrate to prevent the holder or the like from interfering with the chemical strengthening treatment. Consequently, the waviness (Wa) after the chemical strengthening treatment can be restricted to a certain degree or less. Thus, the resulting glass substrate allows the magnetic head to float stably.

In the chemical strengthening step in the method for manufacturing a magnetic disk according to this invention, the glass substrate may be moved with respect to the chemical strengthening agent. Therefore, a fresh flow of the chemical strengthening agent always comes in contact with the main surfaces of the glass substrate to prevent the holder or the like from interfering with the chemical strengthening treatment. Consequently, the waviness (Wa) after the chemical strengthening treatment can be restricted to a certain degree or less. Thus, the resulting glass substrate allows the magnetic head to float stably.

Thus, the method of the invention including the chemical strengthening step restricts the waviness (Wa) to a certain degree or less, so that the flying height of the magnetic head is reduced. Thus, the method provides a magnetic disk glass substrate used for magnetic disks capable of high density information recording, and particularly for magnetic disks suitably used in small hard disk drives for portable apparatuses.

The magnetic disk glass substrate manufactured by the method of the invention can provides a magnetic disk allowing the magnetic head to have a lower flying height and achieving high-density information recording, and particularly a magnetic disk suitably used in hard disk drives for portable information apparatuses.

Since in the method for manufacturing the magnetic disk, the magnetic disk glass substrate manufactured by the method of the invention is used, the resulting magnetic disk allows the magnetic head to have a lower flying height and achieves high-density information recording. In particular, the magnetic disk can be suitably used in small hard disk drives for portable information apparatuses.

### BRIEF DESCRIPTION OF THE DRAWING

FIG. 1 is a flow chart of a method for manufacturing a magnetic disk glass substrate according to an embodiment of the present invention; and

FIG. 2 is a perspective view of a chemical strengthening step in a method for manufacturing a magnetic disk glass substrate according to an embodiment of the invention.

### DESCRIPTION OF THE PREFERRED EMBODIMENTS

The invention will be further described with reference to the drawings.

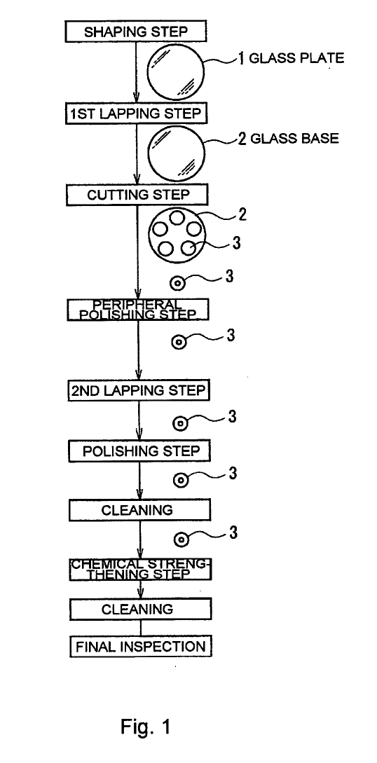

FIG. 1 is a flow chart of the process of a method for manufacturing a magnetic disk glass substrate according to an embodiment of the invention.

(First Lapping Step)

In the manufacturing method of a magnetic disk glass substrate, first, the main surfaces of a glass plate 1 are lapped (ground) to prepare a glass base 2, as shown in FIG. 1. The glass base 2 is cut into glass substrates 3. The main surfaces of the glass substrate 3 are at least polished.

The glass plate 1 to be lapped can have a variety of shapes. For example, the glass plate 1 may be in a rectangular shape or a disk shape. Preferably, a disk-shaped glass plates is used. Disk-shaped glass plates can be reliably lapped with a lapping machine used in the manufacture of known magnetic disk glass substrates at low cost.

The glass plate 1 must be larger than the intended magnetic disk glass substrate. For example, for “a magnetic disk used in a 1 inch hard disk drive (hereinafter, “1 inch HDD”) or a smaller hard disk drive (hereinafter, “smaller HDD”), a magnetic disk glass substrate with a diameter of about 20 to 30 mm is used. Accordingly, the disk-shaped glass plate 1 generally has a diameter of 30 mm or more, and preferably 48 mm or more. A disk-shaped glass plate 1 with a diameter of 65 mm or more can provide a plurality of magnetic disk glass substrates used for “1 inch HDD's”, and is preferable in view of mass production.

The glass plate 1 can be made of, for example, molten glass by a known process, such as pressing, floating, or fusion. The pressing process can manufacture the glass plate 1 at low cost.

Any glass can be used for the glass plate 1 without particular limitation as long as it can be chemically strengthened, and aluminosilicate glass is preferably used. Lithium-containing aluminosilicate glass is particularly preferable. That is, in the method for manufacturing a magnetic disk glass substrate according to this invention, aluminosilicate glass is used as a glass material of a glass substrate. Aluminosilicate glass facilitates precise formation of compressive stress layers having an appropriate compressive stress and a tensile stress layer having an appropriate tensile stress by ion-exchange chemical strengthening, particularly low-temperature ion-exchange chemical strengthening.

The first lapping step is intended to increase the profile precision (for example, flatness of the main surfaces) and dimensional precision (for example, precision in thickness) of the glass plate 1. The lapping is performed by relatively moving the glass plate 1 and a grinding stone or surface plate to grind the main surface of the glass plate 1, with the grinding stone or surface plate pressed against the surface of the glass plate 1. The lapping can be performed with a double side lapping machine using a planetary gear system.

The grinding stone used for the lapping may be a diamond grinding stone. Also, hard abrasive grain is preferably used, such as that of alumina, zirconia, or silicon carbide.

The lapping improves the profile precision of the glass plate 1 to planarize the main surfaces and reduces the thickness of the glass plate 1 to prepare the glass base 2 with a predetermined thickness. The resulting glass base 2 can be easily cut into glass substrates 3. Since the glass base 2 has flat surfaces and a reduced thickness, defects can be prevented which may occur during cutting the glass substrate 3, such as a chip, a crack, and a fracture.

(Peripheral Polishing Step)

Preferably, the periphery of the glass substrate 3 is mirror-polished (peripheral polishing step). The periphery of the glass substrate 3 is a cut surface formed by cutting. By mirror-polishing the periphery, the cut surface can be prevented from generating particulate matter. Consequently, failure resulting from thermal asperity can be prevented in the magnetic disk using the magnetic disk glass substrate. In addition, the mirror-polished surface can prevent microcracks and thus prevent delayed fracture. Preferably, the mirror-polished periphery has an arithmetic mean roughness (Ra) of 100 nm or less.

(Second Lapping Step)

Preferably, another lapping (second lapping step) is performed before a glass substrate polishing step described below. The second lapping step can be performed in the same manner as in the lapping of the glass plate 1. By lapping the glass substrate 3 before polishing, mirror-finished main surfaces can be formed in a shorter time.

(Polishing Step)

The glass substrate 3 cut out from the glass base 2 is polished to give mirror-finished main surfaces to the glass substrate 3.

This polishing step removes cracks in the main surfaces of the glass substrate 3 and the main surfaces have a maximum micro-waviness of, for example, 5 nm or less. The micro-waviness (Ra′, wa) can be represented by the height of waves with wavelengths of 4 μm to 1 mm in a rectangular region of 800 μm by 980 μm, measured by non-contact laser interferometry using MicroXAM manufactured by PHASE SHIFT TECHNOLOGY.

The waviness (Wa) is represented by the height of waves with wavelengths of 300 μm to 5 mm measured by non-contact laser interferometry using a multifunction disk interferometer OPTIFLAT manufactured by PHASE SHIFT TECHNOLOGY.

These two interferometers are different from conventionally used meters based on the tracer method in that the waviness (Wa) or the micro-waviness (Ra′, wa) is measured by scanning the surface of the glass substrate 3 with light. Specifically, OPTIFLAT uses white light (wavelength: 680 nm) and MicroXAM uses laser light (wavelength: 552.8 nm). A predetermined region of the surface of the glass substrate 3 is scanned with the light, and reflected light from the glass substrate 3 is combined with reflected light from a reference surface. The waviness (Wa) and the micro-waviness (Ra′, wa) are calculated from the interference fringes produced at the combined point.

The glass substrate 3 having the above-described mirror-polished main surfaces can provide a magnetic disk that allows the magnetic head to have a flying height of, for example, about 10 nm. Also, the mirror-polished main surface of the glass substrate 3 facilitates uniform chemical strengthening treatment even in microfabricated regions and prevents microcracks and, thus, delayed fracture.

For performing the polishing step, for example, a surface plate with an abrasive cloth (for example, polishing pad) is pressed against the main surface of the glass substrate 3, and the glass substrate 3 and the surface plate are relatively moved while polishing liquid is being fed to the surface of the glass substrate 3. The polishing liquid preferably contains abrasive grain. For example, colloidal silica grain can be used as the abrasive grain. Preferably, the abrasive grain has an average grain size of 10 to 200 nm.

(Chemical Strengthening Step)

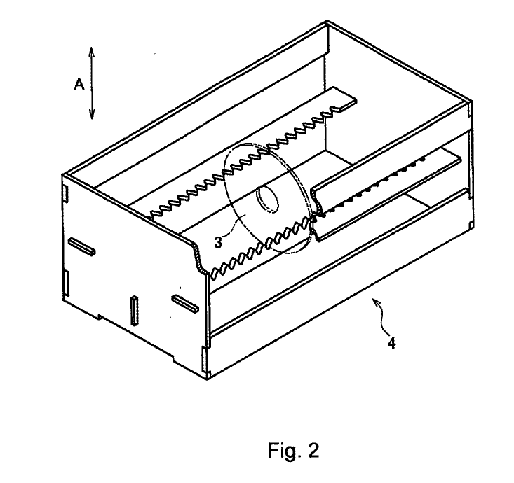

FIG. 2 is a perspective view of the chemical strengthening step in the method according to the embodiment of the invention.

After the polishing step and cleaning, the glass substrate 3 is subjected to chemical strengthening treatment. The chemical strengthening treatment causes high compressive stress at the surfaces of the magnetic disk glass substrate to increase the impact resistance. In particular, a glass substrate 3 made of aluminosilicate glass is suitable for chemical strengthening treatment.

The chemical strengthening treatment is performed by bringing a chemical strengthening agent into contact with the glass substrate 3. In the chemical strengthening step, the chemical strengthening agent contains primary ions with an ion radius larger than that of the ions in the glass substrate 3. By bringing such a solution into contact with the glass substrate 3, ion exchange occurs. As shown in FIG. 2, the chemical strengthening treatment is performed in a chemical strengthening bath. The glass substrate 3 is held by a holder 4 and immersed in the chemical strengthening agent containing ions with larger ion radius than those of the glass substrate 3.

The chemical strengthening bath and the holder 4 for the chemical strengthening step can be made of any material without particular limitation as long as it has high corrosion resistance and does not produce dust. This is because the chemical strengthening agent contains an oxidizing salt or an oxidizing molten salt, and because this step is performed at a high temperature. Use of highly corrosion-resistant material prevents damage to the glass substrate and generation of dust. Accordingly, the chemical strengthening bath is preferably made of quartz. Stainless steel may be used for the chemical strengthening bath, including corrosion-resistant martensitic stainless steel and austenitic stainless steel. Quartz is superior in corrosion resistance, but is expensive. An appropriate material may be selected in view of profitability. A conventionally used holder may be used as the holder 4. The holder 4 catches peripheries of a plurality of glass substrates 3 to hold the glass substrates.

A heated molten salt may be used as the chemical strengthening agent. Specifically, the chemical strengthening agent preferably contains an alkali metal nitrate, such as potassium nitrate, sodium nitrate, or lithium nitrate. The lithium content in the nitrate is preferably 0 to 2000 ppm. Such a salt for the chemical strengthening agent can give a predetermined stiffness and impact resistance to the magnetic disk glass substrate, particularly to a lithium-containing aluminosilicate glass substrate, through the chemical strengthening step. If the lithium ion content in the molten salt of the chemical strengthening agent is excessively high, ion exchange is inhibited, and consequently it becomes difficult to obtain desired tensile stress or compressive stress.

Ion exchange may be performed by a known method, such as low-temperature ion exchange, high-temperature ion exchange, surface crystallization, or glass surface dealkalization. Preferably, a low-temperature ion exchange method is applied. The low-temperature ion exchange method is performed at a temperature of the annealing point or less of the glass or less.

In the low-temperature ion exchange method applied in the embodiment, alkali metal ions in the glass are replaced with other alkali metal ions having a larger ion radius than the alkali metal ions in the glass substrate at a temperature of the annealing point or less to increase the volume of ion-exchanging portion so that a compressive stress is produced at the surface of the glass substrate to strengthen the surface.

In the chemical strengthening step, the chemical strengthening agent is preferably heated to a temperature of 280 to 660° C., particularly 300 to 400° C., from the viewpoint of appropriate ion exchange. The time for which the glass substrate 3 is in contact with (immersed in) the chemical strengthening agent is preferably several hours to tens of hours.

Preferably, the glass substrate 3 is preheated to a temperature of 100 to 300° C. before coming into contact with the chemical strengthening agent.

Furthermore, the relative movement of the glass substrate 3 and the chemical strengthening agent is appropriately controlled in the chemical strengthening step. For example, the chemical strengthening agent is allowed to flow with the glass substrate 3 fixed so that a fresh flow of the chemical strengthening agent always comes in contact with the main surfaces of the glass substrate 3. In order for the chemical strengthening agent to flow, a pump may be used to circulate and stir the chemical strengthening agent in the chemical strengthening bath, or an ultrasonic vibrator or a bubble generator may be used to vibrate or swing the chemical strengthening agent. Thus, a fresh flow of the chemical strengthening agent can always come in contact with the main surfaces of the glass substrate 3. The chemical strengthening agent may be circulated by convection resulting from the temperature distribution of the chemical strengthening agent in the chemical strengthening bath.

Alternatively, the glass substrate 3 may be relatively moved with respect to the chemical strengthening agent. Specifically, the glass substrate 3 held by the holder 4 as shown in FIG. 2 is moved in the chemical strengthening agent in a direction for a predetermined time at predetermined time intervals, or is reciprocated (swung) in the chemical strengthening agent so that a fresh flow of the chemical strengthening agent always comes into contact with the main surfaces of the glass substrate 3.

By allowing the chemical strengthening agent to flow with respect to the glass substrate 3, or by moving the chemical strengthening agent with respective to the glass substrate 3, a fresh flow of the chemical strengthening agent is always brought into contact with the main surfaces of the glass substrate 3. Thus, the glass substrate 3 is favorably treated with the chemical strengthening agent to prevent the increase in waviness (Wa) of the surfaces of the glass substrate 3.

The waviness (Wa) can be measured with, for example, a multifunction disk interferometer OPTIFLAT, as described above, and is calculated from the following equation for waves with wavelengths (distances between crests or between troughs) of about 300 μm to 5 mm.
Wa=(1/N)Σᵢ₌₁^{N}|Xi−Xa|

In the formula, Xi represents a measured value (height from a reference level to the curve of a wave) at a measuring point, Xa represents the average of measured values at measuring points, and N represents the number of measuring points.

Hence, the waviness (Wa) represents the average of absolute values of the deviations from a centerline to the curves. The centerline here refers to a straight line that extends parallel to the average line of the measured curve, and that defines equivalent areas at both sides together with the measured curves. The waviness (Wa) can be represented by the average height of waves with wavelengths of 300 μm to 5 mm in a region surrounded by two concentric circles defined by points predetermined distances away from the center on the surface of the glass substrate 3, measured by non-contact laser interferometry. For example, U.S. Pat. Nos. 5,737,081 and 5,471,307 have described a method of the measurement in detail.

After the completion of the chemical strengthening step, the glass substrate 3 is cooled and cleaned, as shown in FIG. 1. Thus, a final product (magnetic disk glass substrate) is completed.

In the present invention, a relationship between a glide height, or the flying height, in the HDD and the waviness (Wa) at the surfaces of the glass substrate 3 after the chemical strengthening step can be previously set, and the conditions of the flow of the chemical strengthening agent with respect to the glass substrate 3 can be set so as to assign the waviness (Wa) such a value as the glide height is a predetermined value or less.

Alternatively, a relationship between the glide height and the waviness (Wa) at the surfaces of the glass substrate 30 after the chemical strengthening step is previously set, and the conditions of the movement of the glass substrate 3 with respect to the chemical strengthening agent may be set so as to assign the waviness (Wa) such a value as the glide height is a predetermined value or less.

Preferably, the glide height is set at, for example, 10 nm or less.

As for the relationship between the glide height, or the glide height, and the waviness (Wa) at the surface of the glass substrate 30 after the chemical strengthening step, for example, Japanese Unexamined Patent Application Publication (JP-A) No. 2000-348332 has described that the glide height and the micro-waviness (Ra′, wa) have a correlation. The glide height probably has a correlation with the waviness (Wa) (arithmetic mean height of waves with wavelengths of 300 μm to 5 mm) at the surfaces of the glass substrate 3.

The thus produced magnetic disk glass substrate can be suitably used for magnetic disks with thicknesses of less than 0.5 mm, and particularly for magnetic disks with small thicknesses of 0.1 to 0.4 mm. The magnetic disk glass substrate can also be suitably used for small magnetic disks with diameters (outer diameter) of 30 mm or less. Thin or small magnetic disks with such sizes are installed in 1 inch HDD's or 0.85 inch HDD's smaller than the 1 inch HDD's. Hence, the magnetic disk glass substrate according to the embodiment can be suitably used for a magnetic disk installed in a 1 inch HDD or 0.85 inch HDD.

For the magnetic disk built in the 1 inch HDD, the magnetic disk glass substrate has a diameter of about 27.4 mm, and a thickness of 0.381 mm. For the magnetic disk build in the 0.85 inch HDD, the magnetic disk glass substrate has a diameter of about 21.6 mm.

While the diameter of the magnetic disk glass substrate of the invention is not particularly limited, the characteristic features of the magnetic disk glass substrate are advantageous particularly in the manufacture of small magnetic disk glass substrates. The small magnetic disk glass substrate mentioned herein is used for magnetic disks with, for example, a diameter of 30 mm or less, or a thickness of 0.5 mm or less. Accordingly, the manufacturing method of the magnetic disk glass substrate according to the embodiment can be applied to the manufacture of glass substrates with a diameter of 30 mm or less, or a thickness of 0.5 mm or less.

The small magnetic disk with a diameter of 30 mm or less can be used in, for example, a storage of vehicle-mounted apparatuses such as car navigation systems or portable apparatuses such as PDA's and mobile phone units. The magnetic disk used for these apparatuses requires higher durability and impact resistance than the magnetic disk used for fixed apparatuses.

(Formation of Magnetic Recording Layer)

For a magnetic disk according to an embodiment of the present invention, a magnetic recording layer is formed on the magnetic disk glass substrate prepared as above. The magnetic recording layer may be formed of, for example, a cobalt (Co)-based ferromagnetic material. In particular, the magnetic recording layer is preferably formed of cobalt-platinum (Co—Pt) or cobalt-chromium (Co—Cr) ferromagnetic material that can lead to a high coercive force. The formation of the magnetic recording layer can be preformed by DC magnetron sputtering.

An underlayer or the like may be formed between the glass substrate and the magnetic recording layer, if necessary. The underlayer can be formed of an Al—Ru alloy or a Cr-based alloy.

The magnetic recording layer may be covered with a protective layer for protecting the magnetic disk against the impact from the magnetic head. The protective layer is preferably formed of a hard hydrogenated carbon film.

In addition, a PFPE (perfluoro polyether) lubricating layer may be formed over the protective layer to alleviate the interference between the magnetic head and the magnetic disk. The lubricating layer can be formed by, for example, dipping.

### EXAMPLES

The present invention will be further described in detail with reference to Examples. However, the invention is not limited to the form of the Examples.

### Example 1

### Manufacture of Magnetic Disk Glass Substrate

The method for manufacturing the magnetic disk glass substrate in Example 1 includes the following steps (1) to (8):

(1) rough lapping step (rough grinding step);

(2) shaping step;

(3) precision lapping step (precision grinding step);

(4) peripheral mirror-polishing step;

(5) first polishing step;

(6) second polishing step;

(7) chemical strengthening step; and

(8) cleaning step.

First, a disk-shaped amorphous aluminosilicate glass base was prepared. The aluminosilicate glass contained lithium. Specifically, the aluminosilicate glass base had a composition of 63.6% by weight of SiO₂, 14.2% by weight of Al₂O₃, 10.4% by weight of Na₂O, 5.4% by weight of Li₂O, 6.0% by weight of ZnO₂, and 0.4% by weight of Sb₂O₃.

(1) Rough Lapping Step

A 0.6 mm thick glass sheet made of molten aluminosilicate glass was used as the glass base. The glass sheet was formed into a disk-shaped glass substrate with a diameter of 22.9 mm and a thickness of 0.6 mm using a grinding stone.

Any aluminosilicate glass can be used as the material of the glass sheet, as long as containing 58% to 75% by weight of SiO₂, 5% to 23% by weight of Al₂O₃, 4% to 13% by weight of Na₂O, and 3% to 10% by weight of Li₂O.

Then, the glass substrate was subjected to the lapping step in order to increase the dimensional precision and profile precision. The lapping step was performed using a double side lapping machine with abrasive grain of #400 in grain size.

(2) Shaping Step

Then, a hole of 6.1 mm in diameter was formed in the center of the glass substrate using a cylindrical grinding stone, and the periphery of the substrate was ground to reduce the diameter to 21.63 mm. The periphery and the inner wall of the glass substrate were chamfered. The surface roughness of the periphery at this point was about 4 μm in terms of maximum surface roughness Rₘₐₓ.

(3) Precision Lapping Step

The main surfaces of the glass substrate were lapped with abrasive grain with a grain size of #1000. Thus, the surface roughness of the main surfaces was set at about 2 μm in terms of maximum surface roughness Rₘₐₓ, and about 0.2 μm in terms of arithmetic mean roughness Ra.

The precision lapping step can more reduce microscopic asperities at the main surfaces of the glass substrate than the foregoing rough lapping step or the shaping step.

(4) Peripheral Mirror-Polishing Polishing

The periphery of the glass substrate was polished with a brush while the glass substrate was rotated, so that the surface roughness of the periphery and inner wall of the glass substrate was set at about 40 nm in terms of the arithmetic mean surface roughness (Ra).

In the peripheral mirror-polishing step, the glass substrates were stacked and their peripheries were polished. In order to prevent surface flaws at the main surfaces of the glass substrate, the peripheral mirror-polishing step was performed before the below-described first polishing step, or before and after the second polishing step.

Thus, the periphery of the glass substrate was mirror-polished to such a mirror surface as can prevent the generation of dust or particulate matter by the peripheral mirror-polishing step.

(5) First Polishing Step

Subsequently, the first polishing step was performed with a double side polishing machine to remove residual flaws and strain.

For the first polishing step, a polishing pad and a polishing liquid were used. The polishing pad was made of polyurethane foam, and the polishing liquid contained cerium oxide and reverse osmosis (RO) water. After the first polishing step, the glass substrate was cleaned using ultrasonic technique in cleaning baths of a neutral detergent, pure water (1), pure water (2), and isopropyl alcohol (IPA) in that order, followed by drying in an IPA vapor bath.

(6) Second Polishing Step

Then, the second polishing step was performed. In this step, the main surfaces were mirror-polished with a soft polishing pad (made of polyurethane foam) and the same double side polishing machine as used in the first polishing step.

The second polishing step is intended to remove cracks certainly while maintaining the flat main surfaces formed by the first polishing step and to reduce the arithmetic mean surface roughness (Ra) of the main surfaces to about 0.4 to 0.1 nm.

More specifically, the second polishing step was performed at a load of 100 g/cm² for 5 minutes, using a polishing liquid containing colloidal silica grains (average grain size: 80 nm) and RO water.

After the second polishing step, the glass substrate was cleaned using ultrasonic technique in cleaning baths of a neutral detergent, pure water (1), pure water (2), and isopropyl alcohol (IPA) in that order, followed by drying in an IPA vapor bath.

(7) Chemical Strengthening Step

After the cleaning, the glass substrate was subjected to chemical strengthening treatment. The chemical strengthening treatment used a chemical strengthening agent that is a molten salt mixture of potassium nitrate, sodium nitrate, and lithium nitrate.

The glass substrate after cleaning and drying was immersed in a chemical strengthening bath containing the chemical strengthening agent and heated to 340 to 380° C., for about 2 to 4 hours. In this instance, a plurality of glass substrates 3 were held by the holder 4 with their peripheries caught by the holder as shown in FIG. 2 so that the entire main surfaces of the resulting magnetic disk glass substrate were chemically strengthened. The holder 4 held the glass substrates 3 in such a manner that the main surfaces were vertical.

The chemical strengthening treatment was thus performed for 3 minutes each at intervals of 30 minutes while the glass substrate held by the holder 4 was vertically reciprocated in the direction indicated by the arrows A shown in FIG. 2. The distance (excursion) of the vertical reciprocation was about 50 to 100 mm, that is, 2.5 to 5 times the diameter (21.6 mm) of the glass substrate 3.

(8) Cleaning Step

After the chemical strengthening step, the resulting glass substrate was rapidly cooled in a water bath of 20° C. for about 10 minutes.

Subsequently, the glass substrate was cleaned by immersing in concentrated sulfuric acid heated to about 40° C. The glass substrate after the cleaning in the sulfuric acid was further cleaned using ultrasonic technique in cleaning baths of pure water (1), pure water (2), and IPA in that order, followed by drying in an IPA vapor bath.

After the cleaning, the main surfaces of the resulting magnetic disk glass substrate were subjected to visual inspection and subsequently thorough inspection by optical reflection, scattering, and transmission. In addition, the main surfaces of the magnetic disk glass substrate were analyzed by electron microscopy. The surfaces were specular without cracks or protuberances (small waves).

Specifically, the magnetic disk glass substrate produced through the above-described steps had ultra-smooth main surfaces with a maximum micro-waviness (Ra′, wa) of 2.5 nm. The maximum micro-waviness (Ra′, wa) is represented by the largest height of waves with wavelength of 4 μm to 1 mm in a rectangular region of 800 μm by 980 μm, measured by non-contact laser interferometry using MicroXAM (manufacture by PHASE SHIFT TECHNOLOGY).

The waviness (Wa), or the average height of waves with wavelengths of 300 μm to 5 mm, was also measured in a region surrounded by two concentric circles defined by points predetermined distances away from the center on the surface of the magnetic disk glass substrate, using a multifunction disk interferometer OPTIFLAT manufactured by PHASE SHIFT TECHNOLOGY. As a result, it was confirmed that the magnetic disk glass substrate had ultra-smooth main surfaces with a waviness (Wa) of 0.7 to 1.1 nm. The waviness (Wa) was calculated from the following equation:
Wa=(1/N)Σᵢ₌₁^{N}|Xi−Xa|

In the formula, Xi represents a measured value (height from a reference level to the curve of a wave) at a measuring point, Xa represents the average of measured values at measuring points, and N represents the number of measuring points.

Also, it was confirmed that the main surfaces was mirror-finished into a smooth surfaces with an arithmetic mean surface Ra of 0.30 nm by the mirror polishing with the colloidal silica abrasive grain (average grain size: 80 nm). The resulting main surfaces with Ra of about 0.l to 0.4 nm without cracks certainly prevent delayed fracture in the chemically strengthened glass substrate.

Furthermore, the resulting magnetic disk glass substrate did not have foreign matter or particulate matter that may cause thermal asperities on the surfaces, nor have foreign matter or cracks on the inner wall of the hole.

### Example 2

### Manufacture of Magnetic Disk

A magnetic disk was manufactured by the following process.

An Al—Ru seed layer, a Cr—W underlayer, a Co—Cr—Pt—Ta magnetic recording layer, and a hydrogenated carbon protective layer were formed in that order on each main surface of the magnetic disk glass substrate produced through the above-described steps with a statically opposed DC magnetron sputtering apparatus. The seed layer reduces the grain size of the magnetic grains of the magnetic recording layer, and the underlayer orients the easy magnetization axis of the magnetic recording layer in the in-plane direction.

The magnetic disk at least includes the magnetic disk glass substrate, which is nonmagnetic, and the magnetic recording layer overlying the magnetic disk glass substrate, a protective layer covering the magnetic recording layer, and a lubricating layer overlying the protective layer.

In Example 2, nonmagnetic metal layers (nonmagnetic underlayers) including the seed layer and the underlayer were provided between the magnetic disk glass substrate and the magnetic recording layer. The layers of the magnetic disk other than the magnetic recording layer are made of nonmagnetic materials. In Example 2, the magnetic recording layer was in contact with the protective layer, and the protective layer was in contact with the lubricating layer.

Specifically, first the Al—Ru seed layer was deposited to a thickness of 30 nm on the magnetic disk glass substrate by sputtering with an Al—Ru alloy (Al: 50 at %, Ru: 50 at %) target. Then, the Cr—W underlayer was deposited to a thickness of 20 nm on the seed layer by sputtering with a Cr—W alloy (Cr: 80 at %, W: 20 at %) target. Then, the Co—Cr—Pt—Ta magnetic recording layer was deposited to a thickness of 15 nm on the underlayer by sputtering with a Co—Cr—Pt—Ta alloy (Cr: 20 at %, pt: 12 at %, Ta: 5 at %, balance being Co) target.

Then, the magnetic recording layer was coated with the hydrogenated carbon protective layer, and further the PFPE (perfluoro polyether) lubricating layer was formed by dipping. The protective layer protects the magnetic recording layer against the impact from the magnetic head.

The resulting magnetic disk was subjected to a glide test using a glide head at a flying height of 10 nm. No foreign matter coming into contact with the magnetic disk was found, and a stable flying state was maintained. The magnetic disk was further subjected to record/reproduction test at 700 kFCl, and a sufficient signal-to-noise ratio (S/N ratio) was obtained with no error.

The magnetic disk was further driven in a 0.85 inch HDD requiring an information recording density of 60 gigabits per square inch. The magnetic disk performed recording and reproduction successfully without problems.

1. A method for manufacturing a magnetic disk glass substrate, comprising:
the chemical strengthening step of bringing a chemical strengthening agent into contact with a glass substrate to perform ion-exchange, wherein the chemical strengthening agent is allowed to flow with respect to the glass substrate.

2. A method for manufacturing a magnetic disk glass substrate, comprising:
the chemical strengthening step of bringing a chemical strengthening agent into contact with a glass substrate to perform ion exchange, wherein the glass substrate is moved with respect to the chemical strengthening agent.

3. The method according to claim 2, wherein the glass substrate is held by a holder, and moved in the chemical strengthening agent with the holder swung at predetermined intervals.

4. A method for manufacturing a magnetic disk, comprising:
the step of forming a magnetic recording layer on a magnetic disk glass substrate prepared by the method as set forth in claim 1.

5. A magnetic disk glass substrate manufactured by the method as set forth in claim 1, the magnetic disk glass substrate including a recording/reproducing region at the main surface thereof and being in a form of disk with a diameter of 1 inch or less, the recording/reproducing region having waves with wavelengths of 300 μm to 5 mm and an average height Wa of 1.0 nm or less, wherein the average height Wa is obtained by measuring the heights of the waves in a region surrounded by two concentric circles defined by points predetermined distances away from the center of the recording/reproducing region, by non-contact laser interferometry, and the average height Wa is derived from the equation:
Wa=(1/N)Σᵢ₌₁^{N}|Xi−Xa|

wherein Xi represents a measured value that is a height from a reference level to the curve of a wave; Xa represents the average of measured values at measuring points; and N represents the number of measuring points.

6. A method for manufacturing a magnetic disk, comprising:
the step of forming a magnetic recording layer on a magnetic disk glass substrate prepared by the method as set forth in claim 2.

7. A method for manufacturing a magnetic disk, comprising:
the step of forming a magnetic recording layer on a magnetic disk glass substrate prepared by the method as set forth in claim 3.

8. A magnetic disk glass substrate manufactured by the method as set forth in claim 2, the magnetic disk glass substrate including a recording/reproducing region at the main surface thereof and being in a form of disk with a diameter of 1 inch or less, the recording/reproducing region having waves with wavelengths of 300 μm to 5 mm and an average height Wa of 1.0 nm or less, wherein the average height Wa is obtained by measuring the heights of the waves in a region surrounded by two concentric circles defined by points predetermined distances away from the center of the recording/reproducing region, by non-contact laser interferometry, and the average height Wa is derived from the equation:
Wa=(1/N)Σᵢ₌₁^{N}|Xi−Xa|

wherein Xi represents a measured value that is a height from a reference level to the curve of a wave; Xa represents the average of measured values at measuring points; and N represents the number of measuring points.

9. A magnetic disk glass substrate manufactured by the method as set forth in claim 3, the magnetic disk glass substrate including a recording/reproducing region at the main surface thereof and being in a form of disk with a diameter of 1 inch or less, the recording/reproducing region having waves with wavelengths of 300 μm to 5 mm and an average height Wa of 1.0 nm or less, wherein the average height Wa is obtained by measuring the heights of the waves in a region surrounded by two concentric circles defined by points predetermined distances away from the center of the recording/reproducing region, by non-contact laser interferometry, and the average height Wa is derived from the equation:
Wa=(1/N)Σᵢ₌₁^{N}|Xi−Xa|

wherein Xi represents a measured value that is a height from a reference level to the curve of a wave; Xa represents the average of measured values at measuring points; and N represents the number of measuring points.
